(19) United States
(12) Patent Application Publication
(10) Pub. No.: US 2004/0237491 A1
(43) Pub. Date: Dec. 2, 2004

(54) Trimmer assembly and mounting for use with lawn mower

(76) Inventors: Brent Heighton, Kalamazoo, MI (US); Kenneth Abbott, Kalamazoo, MI (US)

Correspondence Address: FLYNN THIEL BOUTELL & TANIS, P.C., 2026 RAMBLING ROAD, KALAMAZOO, MI, 49008-1699, US

(21) Appl. No.: 10/447,983

(22) Filed: May 29, 2003

(51) Int. Cl. A01D 34/00

(52) U.S. Cl. 56/12.7

(57) ABSTRACT

A portable powered trimmer and mounting assembly for mounting on a mower deck or shroud of a lawn mower and including an arm assembly which mounts a powered trimmer head thereon. The arm assembly permits the trimmer head to be positioned in a plurality of cutting positions relative to the mower deck, and resiliently mounts the trimmer head for vertical and horizontal floating movement to allow the trimmer head to track both the ground and the contour of obstacles being trimmed around. The resilient mounting of the trimmer head also prevents damage to the trimmer head due to impact with obstacles encountered in the cutting path.

### FIELD OF THE INVENTION

This invention generally relates to trimmers which are utilized in conjunction with lawn mowers.

### BACKGROUND OF THE INVENTION

Maintaining an aesthetically pleasing lawn requires a considerable amount of work. In this regard, property owners typically own both a mower and a separate trimmer or weed whip. Generally, the task of mowing and trimming a lawn involves two separate steps. First, one typically uses the mower to cut grass or vegetation located in easily accessible areas of the lawn, getting as close to obstacles such as trees, walkways, buildings, etc. as possible. Second, the trimmer or weed whip is then used to trim grass in confined areas or areas that are otherwise difficult, if not impossible, to reach with the mower. During the summer months, lawn maintenance tasks can require a significant amount of time. Accordingly, there is a need for equipment which will decrease the amount of time spent on these tasks.

In an attempt to combine the above steps, mowers with onboard trimmer assemblies were developed, thus permitting the mowing and trimming tasks to be carried out simultaneously. In these known arrangements, the trimmers are powered or driven in various ways, such as through the trimmer being directly attached to the primary mower blade for rotation therewith, by mechanically coupling the trimmer to the drive shaft associated with the mower blade via a belt, or through hydraulics. These methods of actuating the trimmer can be burdensome and can complicate assembly and use. Further, many conventional onboard trimmer arrangements are only usable with a particular type of mower, i.e. a push mower, a riding mower, and commercial versions of such mowers.

In recognition of the disadvantages associated with conventional arrangements as briefly described above, the present invention includes a portable powered trimmer arrangement configured for mounting to a mower shroud or deck. The trimmer arrangement can be easily mounted to a mower deck or shroud to accomplish the tasks of mowing and trimming at the same time. An advantage of the invention is that the trimmer head may be positioned in a plurality of configurations for angled or straight trimming. The portable powered trimmer head can also be detached from the mounting assembly and can be used alone to maintain cutting areas unreachable by the user in the mounted position.

The trimmer arrangement incorporates a mounting assembly which can be either clampingly removably engaged with the mower deck according to one embodiment, or according to another embodiment can be permanently attached to the mower deck. A powered trimmer head is provided and is supported on the mounting assembly in an adjustable manner to permit the trimmer head to be positioned in a plurality of cutting positions. This is achieved by utilizing multiple axes of movements both linear and rotational. Further, a biasing arrangement resiliently supports the trimmer head so as to permit same to float in both horizontal and vertical directions. The resilient mounting of the trimmer head prevents damage to the assembly, in addition to permitting the trimmer head to track both the ground contour and the contour of objects being trimmed around. The invention also includes a portable powered trimmer head that can be temporarily or permanently removed from the mounting assembly so as to allow the user to perform trimming tasks without utilizing the mounting assembly.

Other objects and purposes of the invention, as well as structural and functional variations thereof, will be apparent to persons familiar with this type of arrangement upon reading the following specification and inspecting the accompanying drawings.

### BRIEF DESCRIPTION OF THE DRAWINGS

FIG. 1 is a perspective view of the trimmer assembly according to the invention in use with a commercial mower;

FIG. 2 is an enlarged, fragmentary detail view of the trimmer assembly shown in FIG. 1;

FIG. 3 is an enlarged, fragmentary overhead view of the mower deck and trimmer assembly shown in FIG. 1;

FIG. 4 is an enlarged, fragmentary front view of the mower deck and trimmer assembly shown in FIG. 1;

FIG. 5 is an enlarged, fragmentary front view similar to FIG. 4, but showing the trimmer head in an edging position which orients the flail line at an angle relative to the object to be trimmed;

FIG. 6 is a perspective isolated view of the trimmer assembly according to the invention;

FIG. 7 is a partially exploded view of the trimmer assembly;

FIG. 8 is an overhead view of the slider arm;

FIG. 9 is an enlarged cross-sectional view taken generally along line 9-9 in FIG. 8;

FIG. 9A is an enlarged overhead view of the rotatable disc;

FIG. 9B is an enlarged cross-sectional view taken generally along line 9B-9B in FIG. 9A;

FIG. 10 is a front view of the rotating arm;

FIG. 11 is a perspective side view of the trimmer mounting sleeve;

FIG. 12 is an end view of the trimmer mounting sleeve as seen generally along line 12-12 in FIG. 11;

FIG. 13 is an enlarged cross-sectional view taken generally along line 13-13 in FIG. 12;

FIG. 14 is a perspective view of the trimmer head in use with the portable battery pack;

FIG. 15 is an exploded perspective view of the trimmer head and portable battery pack;

FIG. 16 is a perspective view of an alternative embodiment of the trimmer assembly in use with a residential riding lawn mower;

FIG. 17 is an enlarged, fragmentary cross-sectional view taken generally along line 17-17 in FIG. 16;

FIG. 18 is a perspective view of the trimmer assembly of FIG. 16 in use with a residential push mower;

FIG. 19 is a perspective view similar to FIG. 18, but with the trimmer assembly mounted in an alternative position;

FIG. 20 is a perspective view of a further embodiment of the trimmer assembly incorporating a stabilizer arrangement;

FIG. 21 is a fragmentary side view of the trimmer assembly of FIG. 20 mounted on a mower deck;

FIG. 22 is an enlarged, fragmentary rear view of the stabilizer arrangement;

FIG. 23 is a perspective view of a further embodiment of the trimmer assembly wherein the upper mounting bar is eliminated;

FIG. 24 is a perspective view of a further embodiment of the trimmer assembly;

FIG. 25 is an enlarged and generally vertical cross-sectional view of the rotatable sleeve assembly of FIG. 24;

FIG. 26 is a perspective view of a further embodiment of the trimmer assembly in use with a commercial mower and intended for permanent mounting thereon;

FIG. 27 is an enlarged and generally vertical cross-sectional view of the rotatable sleeve assembly and mower deck of FIG. 26; and

FIG. 28 is a perspective view of the trimmer assembly of FIG. 26 in use with a residential push mower.

Certain terminology will be used in the following description for convenience in reference only, and will not be limiting. For example, the words “upwardly”, “downwardly”, “rightwardly” and “leftwardly” will refer to directions in the drawings to which reference is made. The word “front” will be used to refer to components of the trimmer assembly located furthest from the mower on which the assembly is mounted, and the word “rear” will be used to refer to components of the trimmer assembly located closest to the mower. Further, the words “inwardly” and “outwardly” will refer to directions toward and away from, respectively, the geometric center of the structure and designated parts thereof. Said terminology will include the words specifically mentioned, derivatives thereof, and words of similar import.

### DETAILED DESCRIPTION

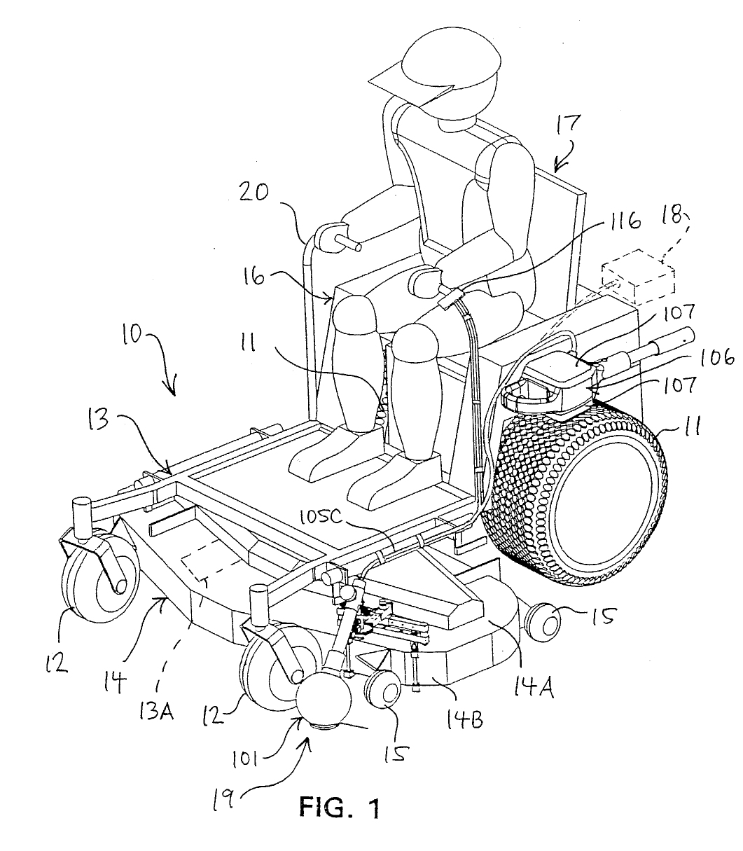

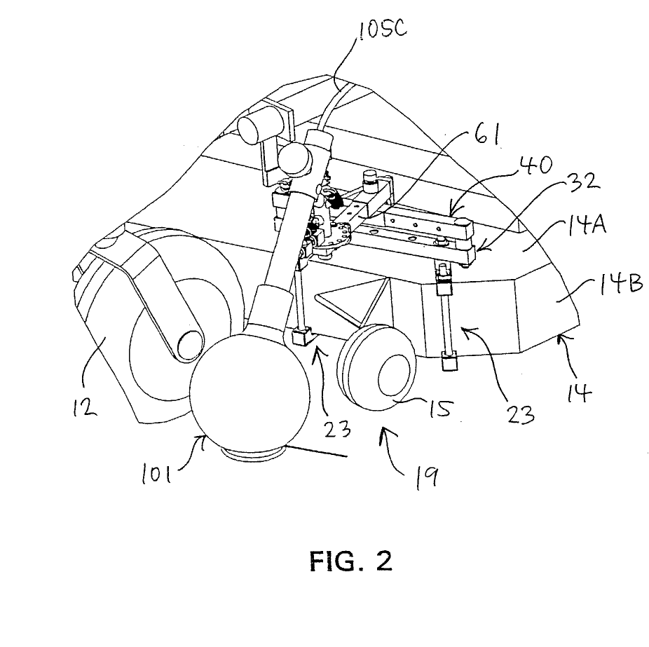

Referring to FIG. 1, there is illustrated a lawn mower 10 including a pair of rear wheels 11 and a pair of front wheels 12 which support a frame 13. A mower deck 14 is mounted on frame 13 and houses therein at least one blade 13A (shown in dotted lines). The deck 14 is additionally supported by front and rear deck wheels 15. Mower 10 also includes a rear housing 16 disposed adjacent an engine (not shown) which propels the mower 10. A seat 17 is supported atop housing 16 for the operator. A battery 18 is provided (shown in dotted lines) for starting the mower 10. It will be appreciated that battery 18 is typically installed under seat 17, and is shown only schematically in FIG. 1 for simplicity. A trimmer assembly 19 according to the present invention is mounted on the mower deck 14.

The mower 10 shown in FIG. 1 is a conventional zero-turning radius mower, wherein the front wheels 12 are swiveling caster wheels, and the engine, which is typically a gasoline or diesel engine, is associated with a transmission which is operable by control handles 20 mounted immediately in front of the operator seat 17. The handles 20 are manipulated by the operator to control the direction of the two rear wheels 11, independently of one another, making it possible for the mower to be turned about a vertical axis which intersects a horizontal axis through the center of the rear wheels 11. It will be appreciated that the mower 10 is only one type of mower with which the trimmer assembly 19 can be utilized, as discussed further below.

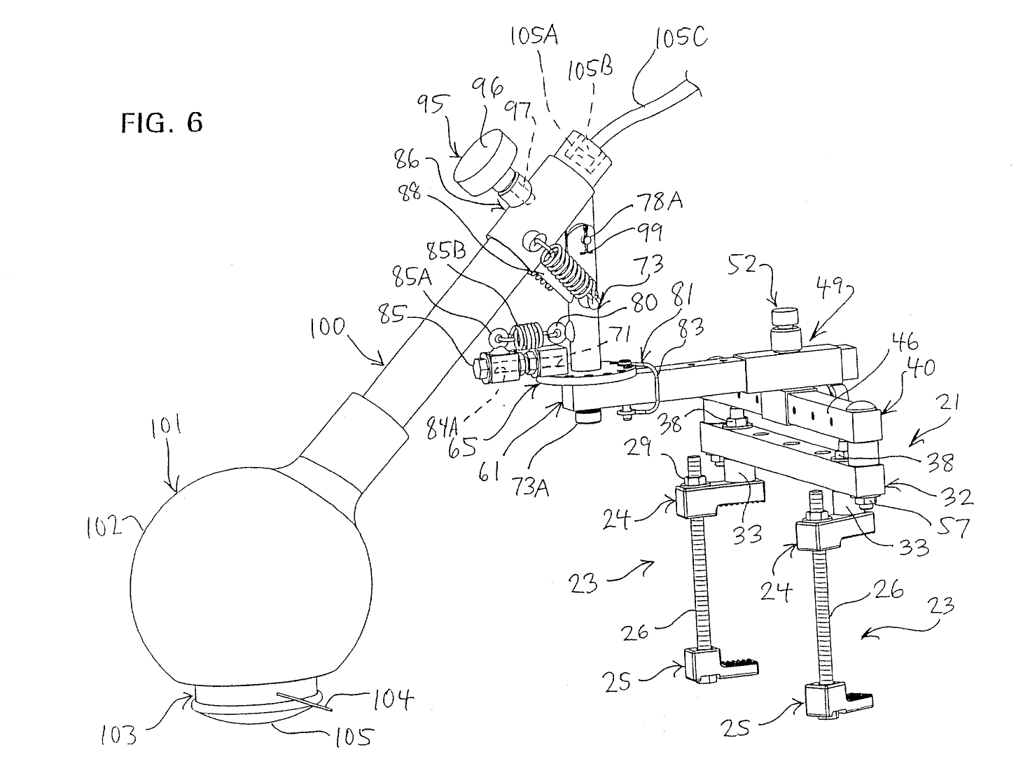

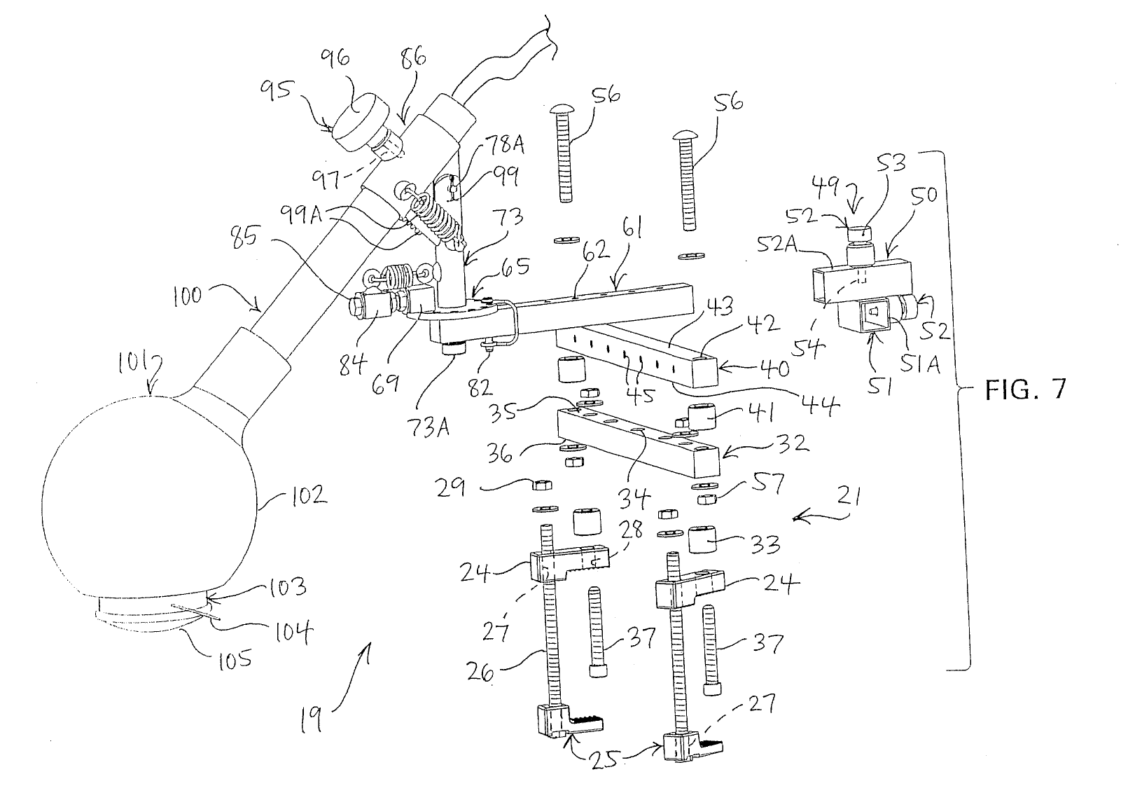

With reference to FIGS. 6 and 7, trimmer assembly 19 includes a mounting arrangement 21 which cooperates with the mower deck 14 to secure assembly 19 to the mower 10. Mounting arrangement 21 includes a pair of sidewardly-spaced and generally C-shaped clamps 23. The clamps 23 are identical to one another and only one of same will accordingly be described. Clamp 23 is defined by an upper toothed clamp member 24, a lower toothed clamp member 25, and an elongate threaded connecting bolt 26. Upper and lower clamp members 24 and 25 each define therein an outer vertically oriented bore 27, and upper clamp member additionally includes an inner vertically oriented bore 28. The connecting bolt 26 extends upwardly through the aligned outer bores 27 of the upper and lower clamp members 24 and 25 to interconnect same so that the toothed surfaces of the respective clamp members 24 and 25 are disposed in opposed and facing relation with one another, a top nut 29 secures the clamp members 24 and 25 on rod 26.

An elongate lower mounting bar 32 is positioned atop the respective upper clamp members 24 through a pair of laterally spaced and annular risers or washers 33. Lower mounting bar 32 defines therein a plurality, and here seven, of horizontally spaced bores 34 which extend between upper and lower generally parallel surfaces 35 and 36 of mounting bar 32. A pair of threaded bolts 37 extend upwardly through the respective inner bores 28 of upper clamp members 24, through the respective risers 33, and through bores 34 of mounting bar 32 located inwardly from the respective endmost bores 34. Nuts 38 are secured to the respective free ends of bolts 37 to secure the clamps 23 to lower mounting bar 32. In the illustrated embodiment, the clamps 23 are spaced slightly inwardly from the respective ends of the mounting bar 32. However, it will be appreciated that the horizontal distance between the clamps 23 can be adjusted as needed simply by utilizing the appropriate bores 34 of lower mounting bar 32.

An elongate upper mounting bar 40 is positioned atop lower mounting bar 32 through a further pair of risers 41. Upper mounting bar 40 defines therein a pair of end bores 42 which extend between upper and lower surfaces 43 and 44 of bar 40. A plurality, and here seven, of laterally spaced side bores 45 are defined in bar 40, and extend between respective upright and generally parallel side surfaces 46 thereof. A sleeve assembly 49 is supported on upper mounting bar 40. Sleeve assembly 49 is defined by upper and lower elongate sleeves 50 and 51 which are fixed to one another in vertically stacked relation, and are arranged in approximately right-angled relation to one another. Sleeves 50 and 51 mount thereon identical locking mechanisms, which in the illustrated embodiment are conventional spring-loaded plunger arrangements 52. Upper sleeve 50 mounts the plunger arrangement 52 on an upper wall 52A thereof, and lower sleeve 51 mounts the plunger arrangement 52 on an upright and rearwardly facing side wall 51A. The plunger arrangement 52 includes a manually operable knob 53 which controls the movement of an elongate plunger 54. The plunger 54 has a free inner end which extends through a corresponding opening defined in the respective wall 52A, 51A.

Sleeve assembly 49 is slidably attached to upper mounting bar 40 by inserting bar 40 into the end of lower sleeve 51, and manipulating knob 53 so that the plunger 54 is retracted away from the bar 40. When sleeve assembly 49 is at the desired location along bar 40, the knob 53 of plunger 52 is released so that the plunger 54 engages within the selected side bore 45 of bar 40. The upper mounting bar 40 and sleeve assembly 49 are attached to lower mounting bar 32 by a pair of threaded bolts 56 which extend downwardly through the respective end bores 42, risers 41, and the respective endmost bores 34 of lower mounting bar 32. Nuts 57 are secured to the respective lower free ends of bolts 56 to secure upper mounting bar 40 to lower mounting bar 32. It will be appreciated that other types of locking mechanisms can be used in place of plungers 52, such as screw clamps or other fasteners.

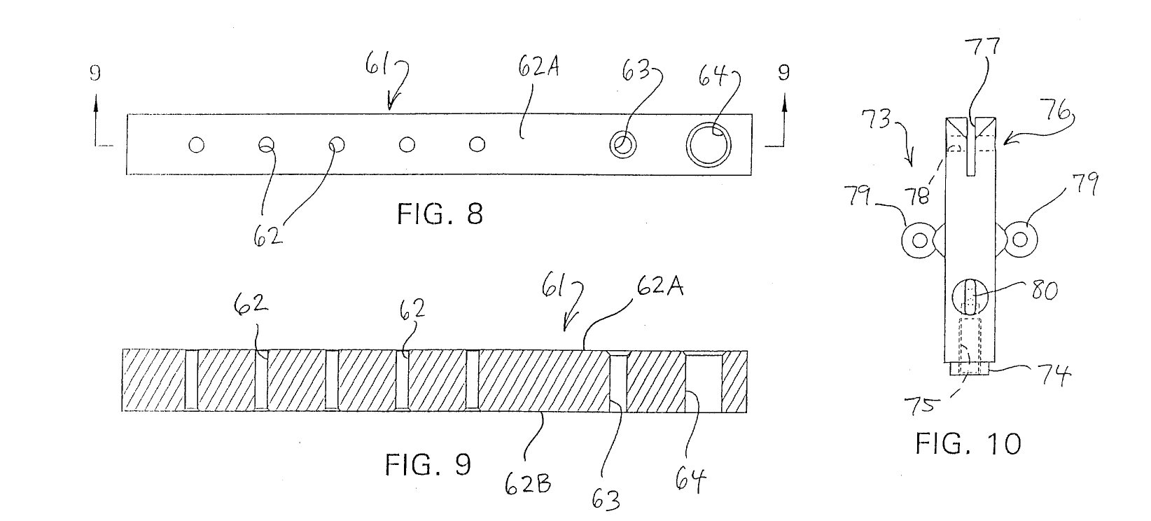

Mounting arrangement 21 also includes a slider arm 61 as shown in FIGS. 7-9. Slider arm 61 defines therein a plurality of bores 62, and here five, which extend between upper and lower surfaces 62A and 62B thereof. Additional bores 63 and 64 are defined in slider arm 61 generally adjacent one end thereof. Inner bore 63 has a diameter which is slightly larger than the diameter of each of the bores 62, and outer bore 64 has a diameter slightly larger than inner bore 63.

The end of slider arm 61 opposite bore 64 is inserted into upper sleeve 50 (with surfaces 62A and 62B parallel to surface 52A) with plunger 54 retracted. When slider arm 61 is in the desired location relative to bar 40, plunger 54 is released and engaged within the selected bore 62 of slider arm 61.

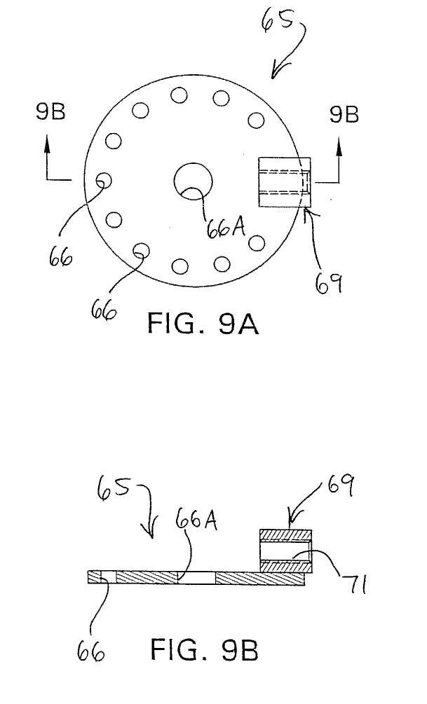

As shown in FIGS. 9A and 9B, a plate-shaped disc 65 is positioned on the upper surface 62A of slider arm 61 adjacent bores 63 and 64. Disc 65 defines therein a plurality of openings 66 which are located in equally spaced relation with one another along the outer periphery of disc 65 and which are of a similar diameter as bore 63 of arm 61. An additional opening 66A is defined centrally within disc 65. A spring block 69 is fixed to the upper surface of disc 65 adjacent the outer periphery thereof. A threaded bore 71 is defined within spring block 69, and extends in a generally horizontal manner therethrough. Disc 65 is supported on slider arm 61 so that opening 66A is aligned with outer opening 64 of arm 61, and so that a selected one of the openings 66 is aligned with bore 63 of slider arm 61.

A rotating upright arm 73 is provided and includes a lower end 74 which defines therein a downwardly opening threaded bore 75 extending along a portion of the vertical extent of arm 73. Lower end 74 is of a reduced diameter as compared to the main body of arm 73, and this diameter is similar to, but slightly smaller than, the diameter of central opening 66A of disc 65. The opposite or upper end of arm 73 is configured as a clevis 76 defining an upwardly-opening slot 77, and an opening 78 rotated 90° from slot 77. Opening 78 receives a pin 78A (FIG. 7). Arm 73 mounts thereon a pair of upper eyelets 79 which are in vertical alignment with one another on opposite sides of arm 73. A lower eyelet 80 is provided on a front side of arm 73 below eyelets 79.

With disc 65 positioned atop slider arm 61, the lower end 74 of arm 73 is inserted into opening 66A, so that the upper edge portion of lower end 74 rests upon the upper surface of disc 65. A threaded fastener or shoulder bolt 73A is then inserted upwardly through opening 64 and into opening 75 defined in the lower end of arm 73 to create a slip-fit between lower end 74, and disc 65 and arm 61. Bolt 73A creates a fixed distance between the upper edge of lower end 74 and lower surface 62B of arm 61, which allows arm 73 to rotate relative to disc 65. A retaining clip 81 is provided to adjustably mount disc 65 atop slider arm 61. More specifically, clip 81 has an upright stem portion 82 which extends through a selected opening 66 of disc 65 and inner opening 63 of slider arm 61. A U-shaped part 83 of clip 81 has a pair of circular or loop-shaped ends, the lower one of which is removably fastened to the lower end of stem portion 82. The rotational position of disc 65, and thus of spring block 69 which is fixed thereto, relative to slider arm 61 is adjusted by removing the lower end of U-shaped part 83 of clip 81 from stem portion 82, removing stem portion 82 from openings 66 and 63, rotating disc 65 to the desired position and aligning another opening 66 in disc 65 with opening 63 in slider arm 61, and then reinstalling clip 81. A further spring block 84 defining a threaded bore 84A therein is fixed to spring block 69 by a threaded bolt 85 which is inserted into the aligned bores of blocks 69 and 84. Spring block 84 mounts thereon a vertically oriented eyelet 85A, which, when spring block 84 is mounted on spring block 69, is vertically aligned and in opposed relation with lower eyelet 80 of arm 73. A tensioning device or spring 85B is then attached between the opposed eyelets 80 and 85A. It will be appreciated that there are a pair of nuts located between the spring blocks 69 and 84 on bolt 85 which allow adjustment of the position of spring block 84 relative to block 69. The positional adjustment of block 84 increases or decreases the tension of spring 85B. Spring 85B controls the positioning of arm 73 and limits the movement thereof.

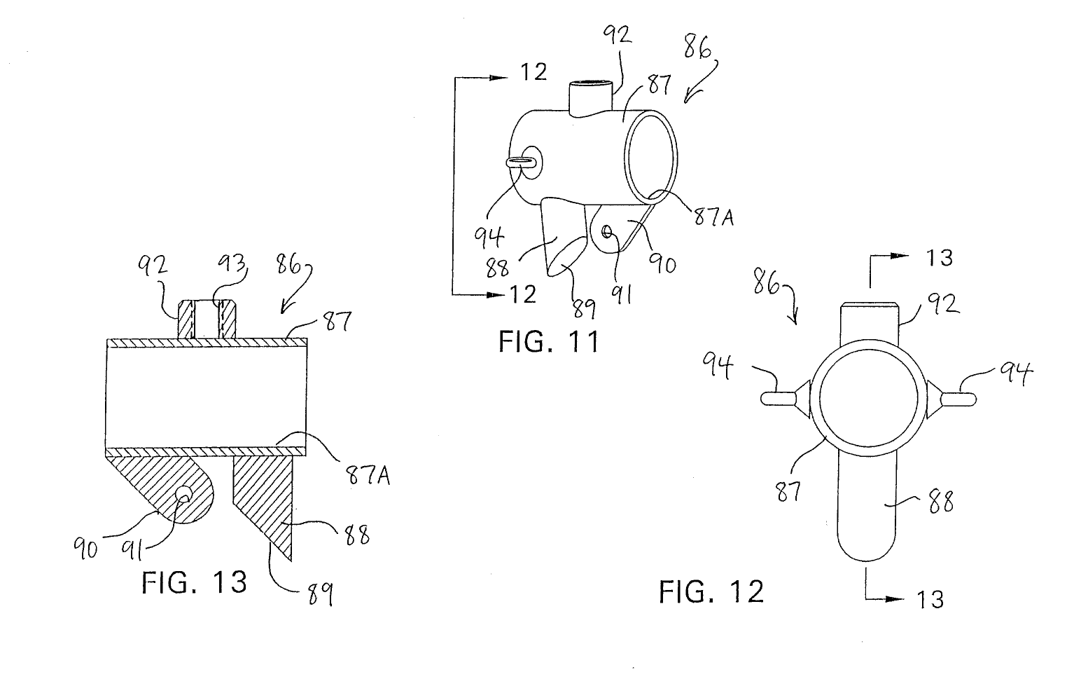

Rotating arm 73 mounts thereon a trimmer mounting sleeve 86, which is shown in FIGS. 11-13. Sleeve 86 includes a main tubular body 87 defining an opening 87A therethrough. A solid rod 88 projects outwardly from a side of main body 87 in a generally perpendicular manner adjacent the lower end of main body 87. Rod 88 defines thereon a beveled or angled lower surface 89, which, when sleeve 86 is mounted on arm 73 as discussed below, is generally vertically oriented. A mounting flange 90 defining an opening 91 therein projects sidewardly from the main body 87 at the opposite end thereof from rod 88. Flange 90 is disposed at an approximately 45 degree angle relative to main body 87, and flange 90 angles inwardly toward rod 88 as same projects downwardly. A cylindrical neck 92 defining a threaded opening 93 therein projects upwardly from main body 87 on an opposite side thereof from rod 88 and flange 90. Neck 92 is oriented centrally between the opposite open ends of main body 87 and is generally perpendicular relative thereto. A pair of eyelets 94 are mounted on the exterior of main body 87 adjacent rod 88. Eyelets 94 project sidewardly from main body 87 in opposite directions, and each are oriented on main body 87 at right angles relative to both rod 88 and neck 92. As shown in FIGS. 6 and 7, a threaded knob or screw clamp 95 is mounted on main body 87. Screw clamp 95 has a manually operated knob 96 and a threaded rod 97 which is threadingly engaged within the neck 92 of main body 87.

Sleeve 86 is mounted to rotating arm 73 by inserting flange 90 into slot 77 of clevis 76. The opening 91 of flange 90 is aligned with the opening 78 and pin 78A is inserted into the aligned openings 91 and 78. A clip 99 is provided to secure pin 98 in place. With the flange 90 secured to arm 73, the beveled lower surface 89 of rod 88 rests against an upright side of the arm 73, and tensioning devices or springs 99A are fastened between the respective eyelets 94 of sleeve 86 and upper eyelets 79 of arm 73. Sleeve 86 is thus secured to arm 73 such that sleeve 86 is pivotable upwardly about pin 78A relative to arm 73 and against the biasing force of springs 99A. Downward movement of sleeve 86 is limited by rod 88 which serves as a vertical stop through its engagement with the outer surface of arm 73. Sleeve 86 and rotating arm 73 are also capable of rotational movement relative to disc 65 and slider arm 61 as discussed below.

Trimmer assembly 19 also includes a trimmer arm 100 and trimmer head 101. Trimmer arm 100 is an elongate, rigid and generally cylindrical and tubular component having an outer diameter which is similar to, but slightly less than, the inner diameter of mounting sleeve 86. Arm 100 rigidly mounts thereon trimmer head 101 at the lower end thereof. Trimmer head 101 includes an outer spherical housing 102 which encloses a conventional electrical motor (not shown). The motor drives a whip head 103 which in turn rotates a flail line or cutting member 104 for cutting vegetation. Trimmer head 101 mounts thereon a rounded bottom cap 105 which, along with the spherical shape of housing 102 helps to prevent the trimmer head 101 from catching the ground or on obstacles on the ground.

The upper end of arm 100 mounts therein an electrical connector 105A configured to mate with an electrical connector 105B of a power cord 105C. The connector 105A is electrically wired to the motor located within housing 102 so that when power cord 105C is connected to arm 100, the motor is provided with electrical power. It will be appreciated that the connecting arrangement including the connector 105A and 105B is a male/female connector arrangement, with the male connector being located on either the arm 100 or cord 105C, and the female connector being located on the opposite component. Further, in the illustrated embodiment, the flail line 104 is provided as part of a conventional semi-permanent arrangement which allows removal of the flail line or filament 104 from the trimmer head 101 by removing the bottom cap 105. When the line 104 is worn or breaks, the line can then be replaced. Alternatively, the flail line can be provided on a spool.

The trimmer arm 100 is mounted to sleeve 86 by inserting the upper end thereof into the lower open end of sleeve 86, and then manually rotating the knob 96 to extend the screw rod 97 until same clamps against the outer surface of arm 100 and locks same into place. The power cord 105C is then connected to connector 105A of arm 100.

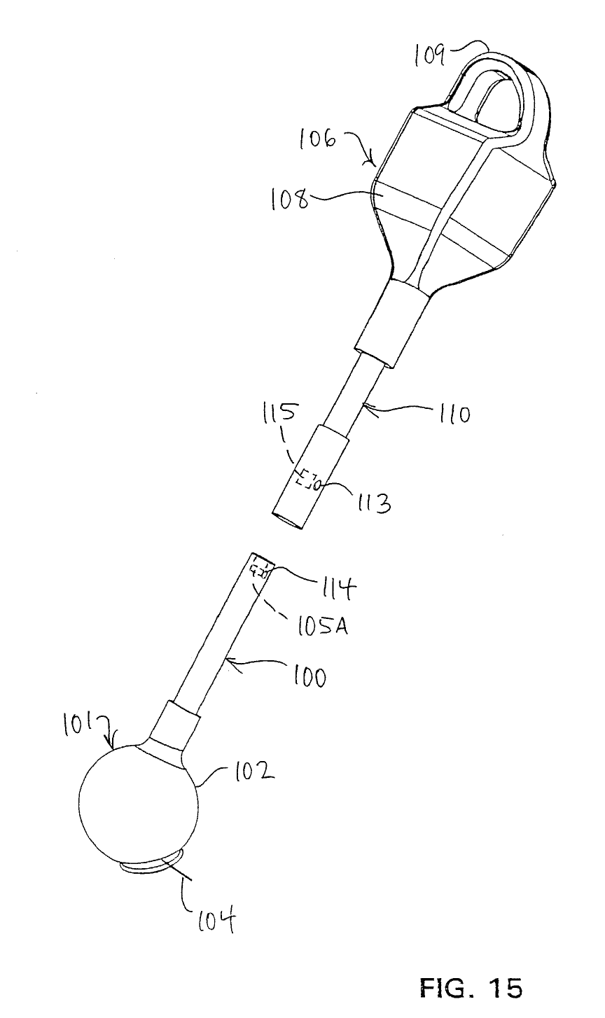

Referring to FIGS. 1, 14 and 15, the trimmer assembly 19 additionally includes a power source 106 which is mounted on the mower 10. In the illustrated embodiment, the power source 106 is mounted on the rear housing 16 above one of the rear wheels 11 by a pair of opposed resilient molded spring clips 107 which are securely mounted to housing 16. In the illustrated embodiment, the power source 106 includes a rechargeable 12V battery pack 108 which mounts thereon a handle 109 and an elongate post 110. Power cord 105C, on an end opposite connector 105B is electrically connected to battery pack 108. Further, post 110 of power source 106 defines therein a pair of openings 113 adjacent the free end on opposite sides thereof (only one of which is shown in FIG. 15) which cooperate with a pair of correspondingly located spring-biased balls 114 provided on opposite sides of the upper end of trimmer arm 100. Post 110 also includes an electrical connector 115 at the free end (shown in dotted lines in FIG. 15), which is configured to mate with the connector 105A of trimmer arm 100 for a purpose as discussed below. An operator switch 116 (FIG. 1) is mounted on one of control handles 20 of mower 10 which is appropriately wired to power cord 105C to allow the operator to selectively power the trimmer head 101 when trimming is desirable or necessary.

As an alternative, and as shown in FIG. 1 in dotted lines, the power cord 105C can be electrically connected to the battery 18 of the mower 10 to power the trimmer head 101. Since the mower battery 18 is constantly being charged while the mower is operating, this alternative eliminates the need to recharge the battery pack 108. Further, use of the mower battery 18 will provide more power to the trimmer head 101 while eliminating wearing of battery pack 108.

The trimmer assembly 19 is mounted to the mower deck 14 by loosening the top nuts 29 and positioning the clamps 23 so that the upper clamp members 24 are atop an upper horizontal wall 14A of the mower deck 14, and the lower clamp members 25 project under an edge portion of an upright side wall 14B of deck 14, with the rods 26 extending along the side wall 14B in generally parallel relationship therewith. The top nuts 29 are then tightened until the teeth of the respective clamps 23 are in firm engagement with the upper wall 14A and the lower edge of side wall 14B of deck 14.

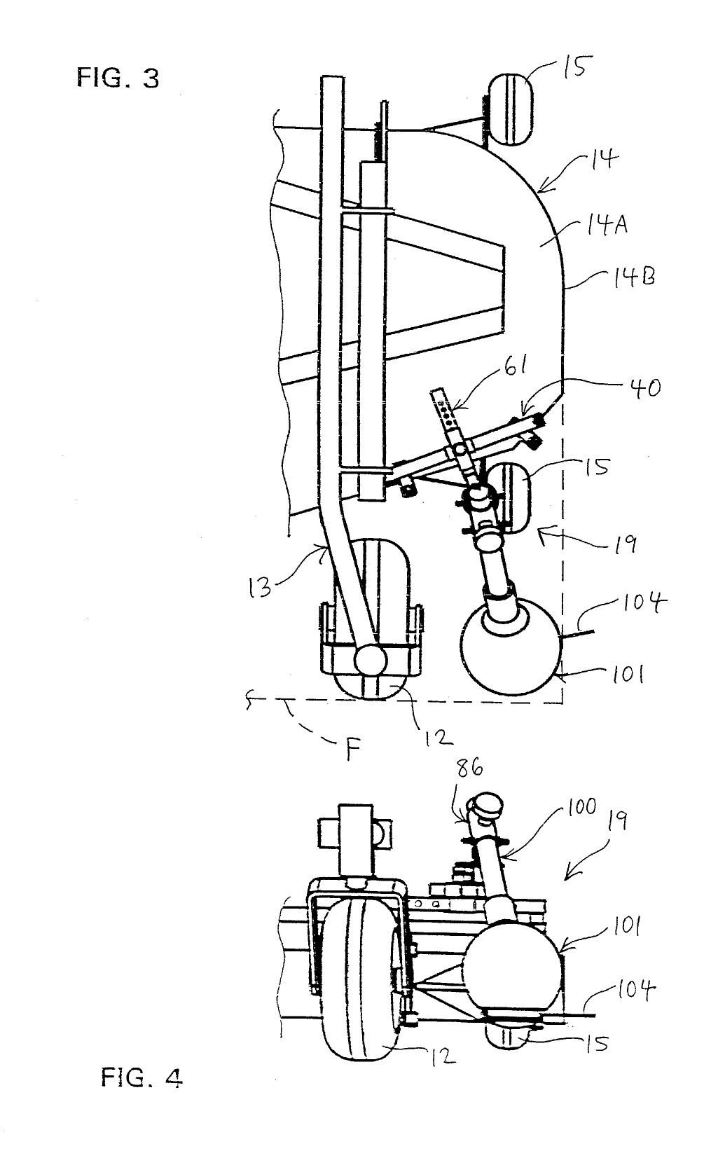

In the illustrated embodiment, the trimmer assembly 19 is mounted rearwardly of the front wheel 12 of the mower 10, and in generally horizontally aligned relation with the upright side wall 14B as best shown in FIG. 3. This mounting location of the trimmer assembly 19 maintains same within the footprint F of the mower 10, which is particularly important with a commercial mower such as that shown in FIG. 1. More specifically, the assembly 19 is mounted so that same is protected from obstacles which may be encountered by the mower 10 during operation, so that the force of any object is taken by the front wheel 12 or the outermost upright side wall 14B of the mower 10 so as to protect the trimmer assembly 19 from damage.

The position of the trimmer head 101 is adjustable, depending upon the configuration of the mower. In this regard, the adjustable mounting of the slider arm 61 relative to the upper mounting bar 40 allows side-to-side adjustment of trimmer head 101, simply by sliding the sleeve assembly 49 along the upper mounting bar 40 and engaging the plunger 54 of the lower spring-loaded plunger 52 within a selected side bore 45 of bar 40. Further, the extension or length of the slider arm 61 relative to the upper mounting bar 40 is adjustable by sliding the arm 61 relative to the upper sleeve 50 and engaging the plunger 54 of the upper spring-loaded plunger 52 within a selected bore 62 of arm 61, which effectively adjusts the distance of the trimmer head 101 from the upper mounting bar 40 and deck 14. Also, the rotational position of the trimmer head 101 (i.e. about a vertical axis as defined by the arm 73) is adjusted by rotating disc 65 relative to slider arm 61, aligning a selected opening 66 with the inner opening 63 of arm 61, and inserting the stem portion 82 of clip 81 into the aligned openings 66 and 63. In this regard, the lower spring 85B serves as the connection between disc 65 and arm 73, and the arm 73 and trimmer arm 100 accordingly follow the rotational movement of the disc 65 during adjustment.

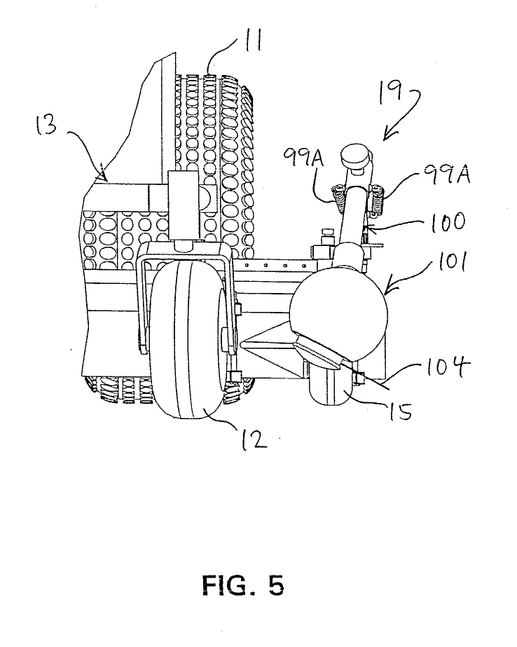

In addition, the vertical position of the trimmer arm 100 is adjusted by sliding the arm 100 relative to and within the mounting sleeve 86 and tightening screw clamp 95 against arm 100 at the desired position, which effectively adjusts the height of the trimmer head 101 relative to the ground. In some situations, it may be desirable to adjust the trimmer arm 100 so that the trimmer head 101 cuts vegetation at a height which is different than the height at which the mower blade cuts, and this is easily accomplished by adjusting arm 100 relative to sleeve 86, as discussed above. As shown in FIGS. 4 and 5, by rotating the trimmer arm 100 relative to sleeve 86, the angular position of the flail line 104 can be adjusted. FIG. 4 shows the trimmer head 101 oriented so that the flail line 104 is generally parallel with the ground, for example, when trimming along or around trees, fences, etc. FIG. 5 shows the trimmer head 101 oriented so that the flail line 104 is oriented at an approximately 45 degree angle relative to the ground, which is preferred when edging along a walkway or sidewalk.

While the trimmer assembly 19 according to the invention is shown in conjunction with a commercial, zero-turning radius mower 10, it will be appreciated that the assembly 19 can be utilized with many types of mowers. In this regard, the distance between the clamps 23 is adjustable, simply by mounting the upper clamp members 24 at the appropriate locations along lower mounting bar 32 utilizing the appropriate bores 34.

In operation, when trimming is desired, the operator actuates switch 116 to power the trimmer head 101 and rotate the flail line 104. If the trimmer head 101 encounters an obstacle on the ground, the trimmer head 101 will pivot upwardly about the horizontal axis defined by pin 78A which interconnects mounting sleeve 86 and arm 73, against the biasing force of the upper springs 99A. Downward pivoting of the trimmer head 101 is limited by vertical stop rod 88. If the trimmer head 101 encounters an object which exerts a lateral or sidewardly directed force on the trimmer head 101, the trimmer head 101 will pivot sidewardly. More specifically, the lateral force acting on the trimmer head 101 will cause rotation of arm 73 relative to slider arm 61, against the biasing force of lower spring 85B. Once the source of the lateral force on the trimmer head 101 is removed, the lower spring 85B will then cause rotation of trimmer arm 100 back to its initial position. The biased arrangement of the trimmer arm 100 and head 101 thus allows limited upward, sideward and limited three-dimensional movement of these components when obstacles are encountered, which can prevent damage to the trimmer head 101, and also allows the trimmer head 101 to follow the contour of the ground and to follow the contour of objects being trimmed around.

It will be appreciated that the biasing arrangement associated with trimmer arm 100 including springs 85B and 99A is only one example of such an arrangement, and other configurations would be within the scope of the present invention. For example, springs 85B and 99A could be replaced with a single spring having one end fixed to the sleeve 86 and an opposite end fixed to the disc 65 to permit limited upward and sideward movement of trimmer arm 100. Alternatively, piston-cylinder units may also be used.

Further, the bores 62 in arm 61, bores 45 in bar 40, and bores 34 in bar 32 may instead be formed as dimples, and thus need not extend completely through the respective component.

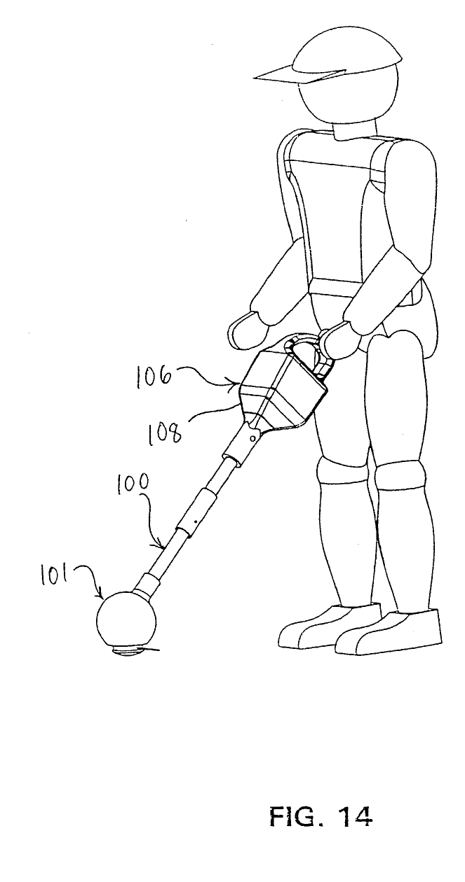

As shown in FIGS. 14 and 15, the trimmer arm 100 and head 101 can, if desired, be used separately from the mower 10. To use the trimmer arm 100 in this manner, the power cord 105C is detached or unplugged from the trimmer arm 100, the screw clamp 95 is loosened, and the trimmer arm 100 and head 101 are removed from sleeve 86. The power source 106 is removed from the mower 10 by pulling same from the spring clips 107. The upper end of the trimmer arm 100 is then inserted into the lower open end of the post 110 and the connectors 105A and 115 are mated, and the spring-biased balls 114 are engaged within the corresponding openings 113 defined in post 110. In this regard, it may be desirable to provide suitably located alignment markings on the post 110 and/or the upper end of the trimmer arm 100 to assist in connecting the two components with one another.

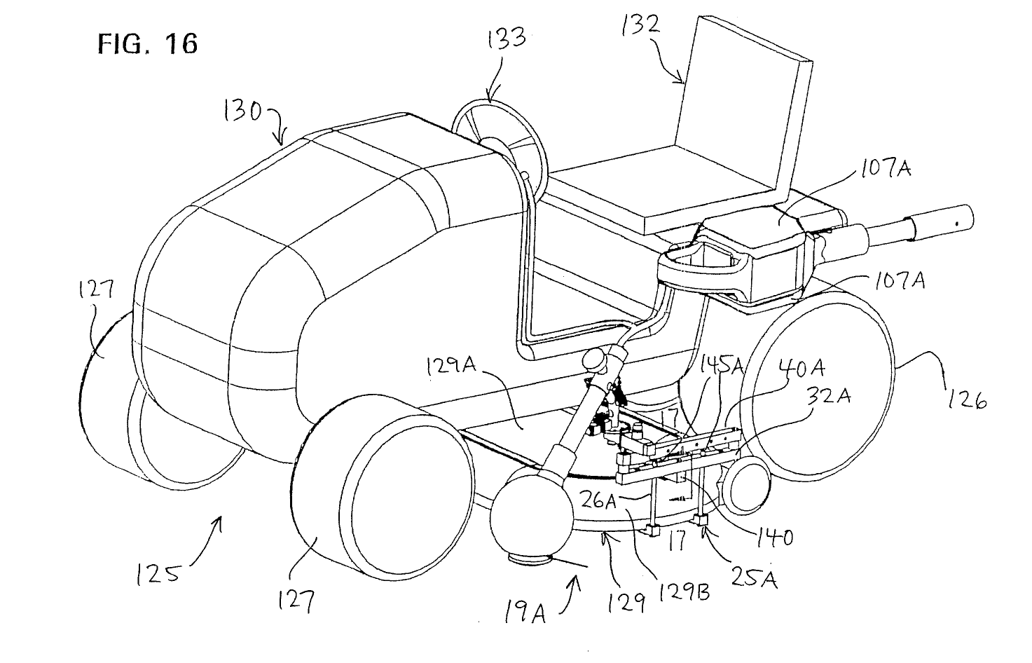

As mentioned above, the adjustability of the trimmer assembly 19 according to the invention allows same to be utilized with different types of mowers. However, some mowers incorporate mower decks which do not have an outer upright wall, such as wall 14B of mower 10. For example, a conventional residential riding mower 125 is illustrated in FIG. 16. Mower 125 has a pair of rear wheels 126 and a pair of front wheels 127 which support a mower frame. A deck 129 is supported on the frame, which houses a rotating mower blade (not shown). The deck 129 has a generally horizontally oriented upper wall 129A which is joined to an outer curved wall 129B. Wall 129B has a lower edge portion spaced a short distance above the ground, but then curves gradually inwardly towards upper wall 129A as same projects upwardly. The mower 125 additionally includes a front housing 130 which encloses a motor (not shown), an operator seat 132, and a steering mechanism 133. The mower 125 incorporates a battery or power source similar to that of mower 10 and is not shown here for purposes of simplicity.

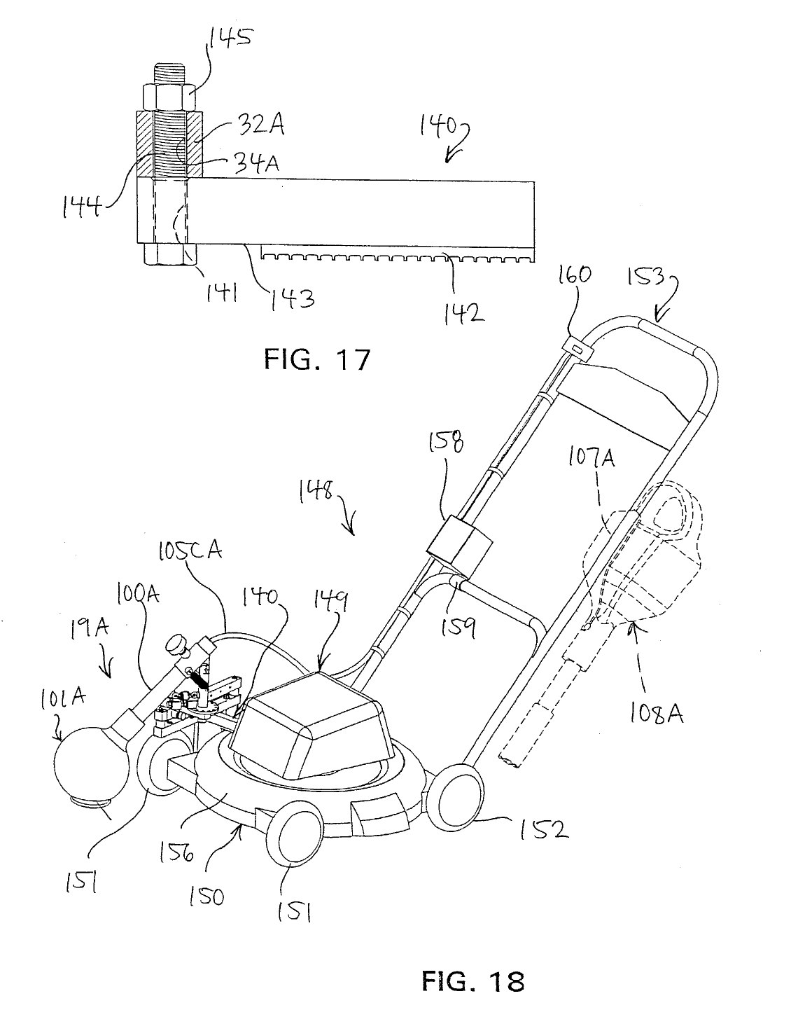

A modified version of the trimmer assembly is mounted on the mower 125 shown in FIG. 16. The trimmer assembly 19A is substantially identical to the trimmer assembly 19, and the same reference numbers plus an “A” are accordingly utilized for components which are identical or similar to the components of trimmer assembly 19. The trimmer assembly 19A includes a clamp bar 140 which takes the place of the upper clamp members 24 of the respective clamps 23 of trimmer assembly 19. As shown in FIG. 17, clamp bar 140 is an elongate solid component which defines therein a bore 141 at one end thereof. Clamp bar 140 mounts thereon a toothed segment 142 on a lower surface 143 thereof, which segment 142 extends along a substantial portion of the length of lower surface 143. Clamp bar 140 is secured to lower mounting bar 32A by means of a fastener such as a threaded bolt 144 which extends upwardly through bore 141 and through a selected bore 34A of mounting bar 32A, and a nut 145 is threaded over the upper free end of bolt 144 to fix clamp bar 140 to bar 32A. As shown in FIG. 17, the clamp bar 140 is fastened to mounting bar 32A so that the toothed segment 142 faces downwardly. In this embodiment, the upper ends of the respective connecting rods 26A project upwardly through a selected pair of bores 34A of mounting bar 32A located on opposite sides of the clamp bar 140 and are secured to bar 32A with nuts 145A.

The trimmer assembly 19A is mounted onto mower 125 by loosening the bottom nuts which secure lower clamp members 25A on the respective connecting rods 26A. The clamp bar 140 is positioned atop the horizontal wall 129A of mower deck 129, the lower clamp members 25A are positioned under the lower edge of wall 129B of deck 129, and the bottom nuts are then tightened to clamp the mower deck 129 between the clamp bar 140 and lower clamp members 25A. The clamp bar 140 projects a significantly greater distance inwardly towards mower 125 than do upper clamp members 24 of trimmer assembly 19. Thus, the clamp bar 140 can be used with a mower deck having an upper horizontally oriented deck surface which is offset inwardly relative to the lower outer edge portion of the deck.

FIG. 18 illustrates the trimmer assembly 19A mounted on a conventional residential push mower 148. Mower 148 includes a housing 149 which encloses a motor (not shown), a deck 150 mounted beneath housing 149 which encloses a mower blade (not shown), and front and rear wheels 151, 152 which support deck 150 and housing 149. Mower 148 also incorporates a handle 153 which is used by the operator to propel the mower 148. The deck 150 of mower 148 has a curved outer wall 156 similar to wall 129B of mower 125, and thus use of the clamp bar 140 is desirable in this embodiment.

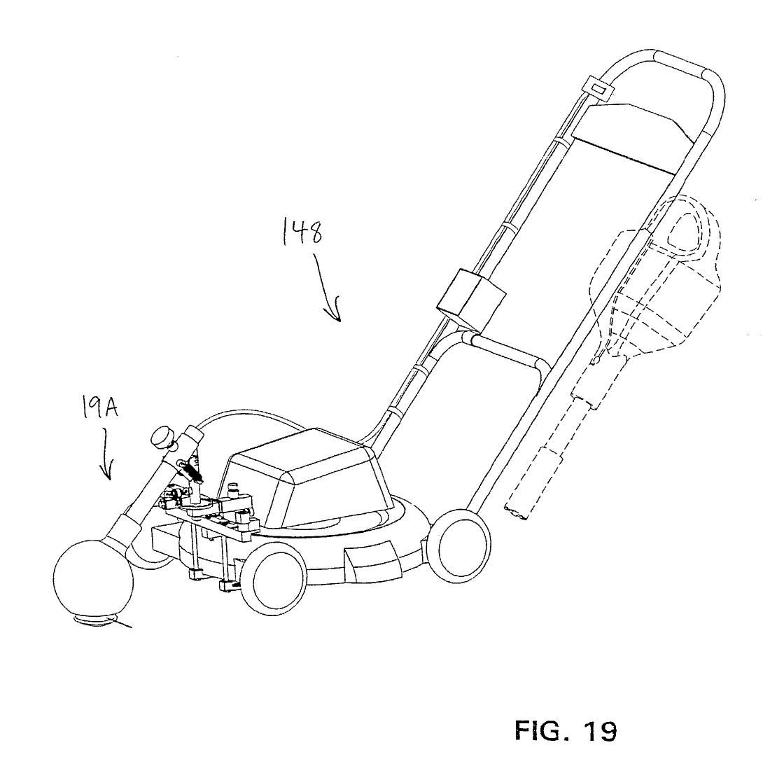

To power the trimmer head 101A power cord 105CA in this embodiment is electrically connected to a power source or battery pack 158 (here a 12V battery pack) which is securely mounted to the mower handle 153 by a clamp 159. A switch 160 is mounted on the handle 153 and is provided to allow the operator to operate the trimmer head 101A when trimming is desired. In this embodiment, the trimmer assembly 19A is mounted to a side of the mower deck 150 opposite the discharge side, and so that the trimmer head 101A is located forwardly of the front wheel 151 of the mower 148. However, it may be desirable to mount the trimmer assembly 19A on the front of the mower 148 as shown in FIG. 19, depending upon operator preferences and/or the configuration of the particular mower.

As shown in dotted lines in FIGS. 18 and 19, battery pack 108A may be provided as an alternative to the battery pack 158 mounted on mower handle 153. In this situation, the battery pack 108A is mounted to the mower handle 153 via spring clips 107A which are firmly secured to a side bar of handle 153. The battery pack 108A can then be removed from spring clips 107A and connected to trimmer arm 101A in the manner discussed above when use of the trimmer head 101A separate from the mower 148 is desirable.

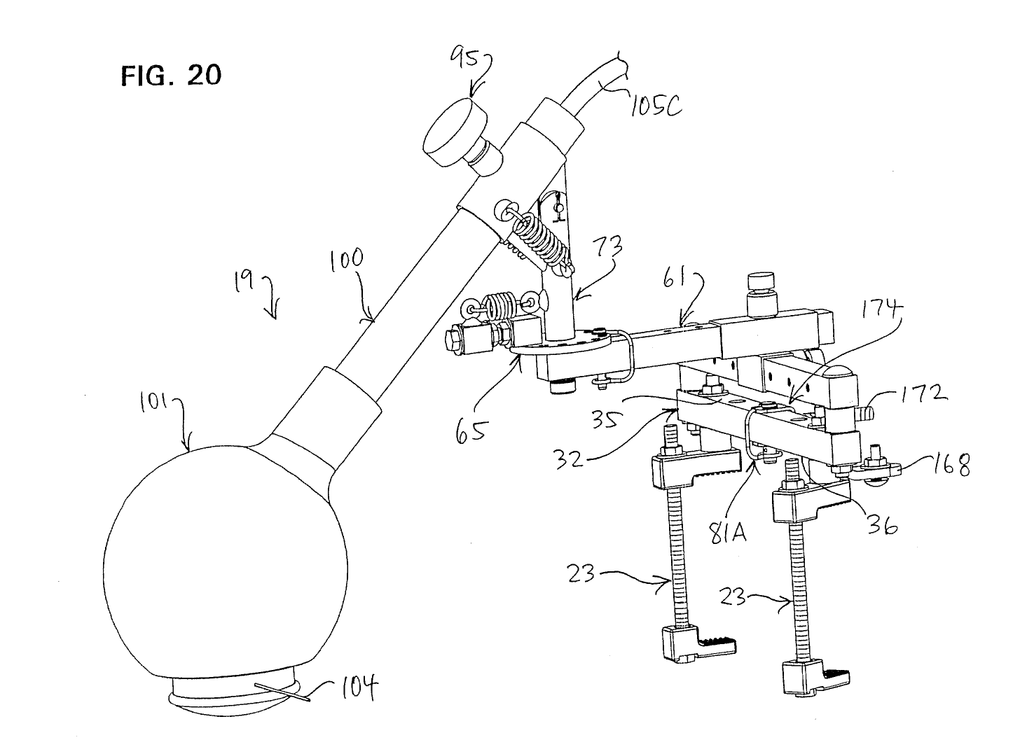

As shown in FIGS. 20-22, trimmer assembly 19 is shown incorporating a stabilizer arrangement 165 which may be desirable or necessary with certain types of mowers. Stabilizer arrangement 165 includes a first arm 166 defined by a vertically oriented leg 167 joined at its lower end to a horizontal leg 168. Vertical leg 167 defines therein a vertically elongated slot 169 as shown in FIG. 22, and horizontal leg 168 defines therein an opening 170 which receives therein a threaded bolt 170A. Stabilizer arrangement 165 additionally includes a second arm 171 having a threaded inner end 172 which penetrates the elongate slot 169 of vertical leg 167 and is secured to leg 167 by a nut 173. The elongation of slot 169 permits adjustment of the height of the arm 166 which allows for irregularities in the mower deck. Second arm 171 has an outer generally U-shaped end 174 which engages over upper and lower surfaces 35 and 36 of lower mounting bar 32. Each of the legs 174A and 174B of U-shaped end 174 defines therein an opening, which openings are aligned with a selected bore 34 of mounting bar 32. A clip 81A similar to clip 81 is then utilized to connect U-shaped end 174 to mounting bar 32.

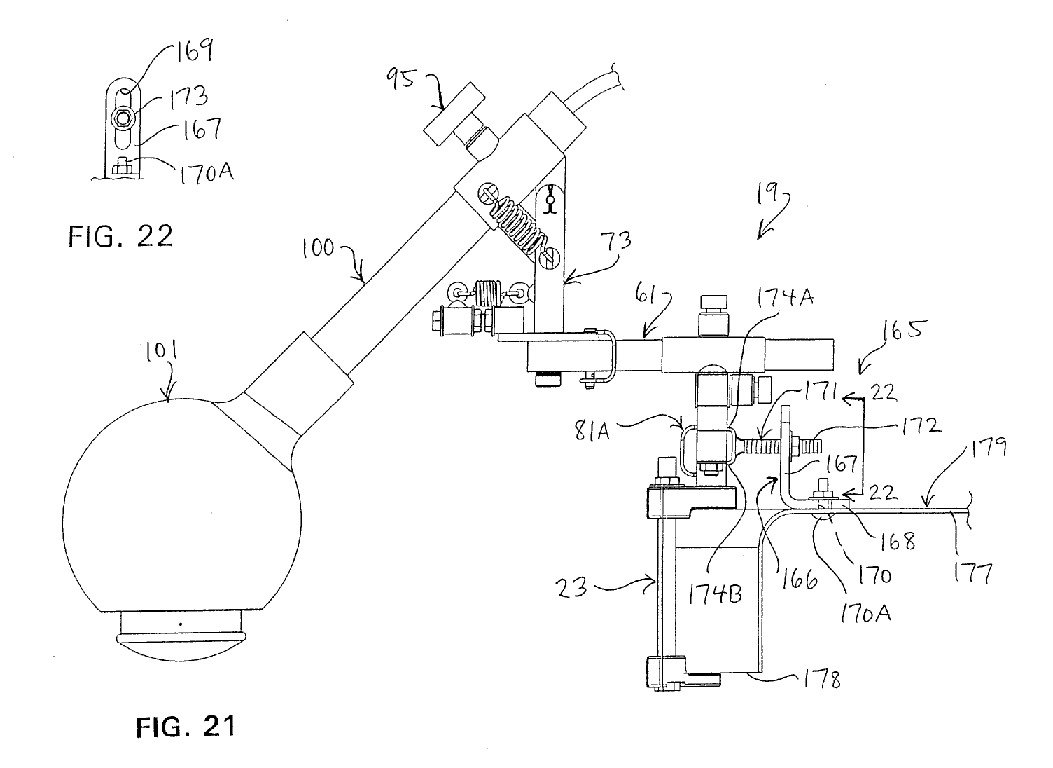

As shown in FIG. 21, clamps 23 are secured to the upper horizontally oriented wall 177 and lower edge portion 178 of mower deck 179, and the horizontal leg 168 of stabilizer arrangement 165 is fixed to an inner portion of upper wall 177 via bolt 170A. It will be appreciated that the mower deck 179 shown in FIG. 21 has a curved configuration when viewed from above, thus requiring that the clamps 23 be pivoted slightly inwardly towards one another. Certain mowers may make it desirable or necessary to provide stabilization of the trimmer assembly 19 and to reduce vibration, in which case the stabilizer arrangement 165 can be utilized.

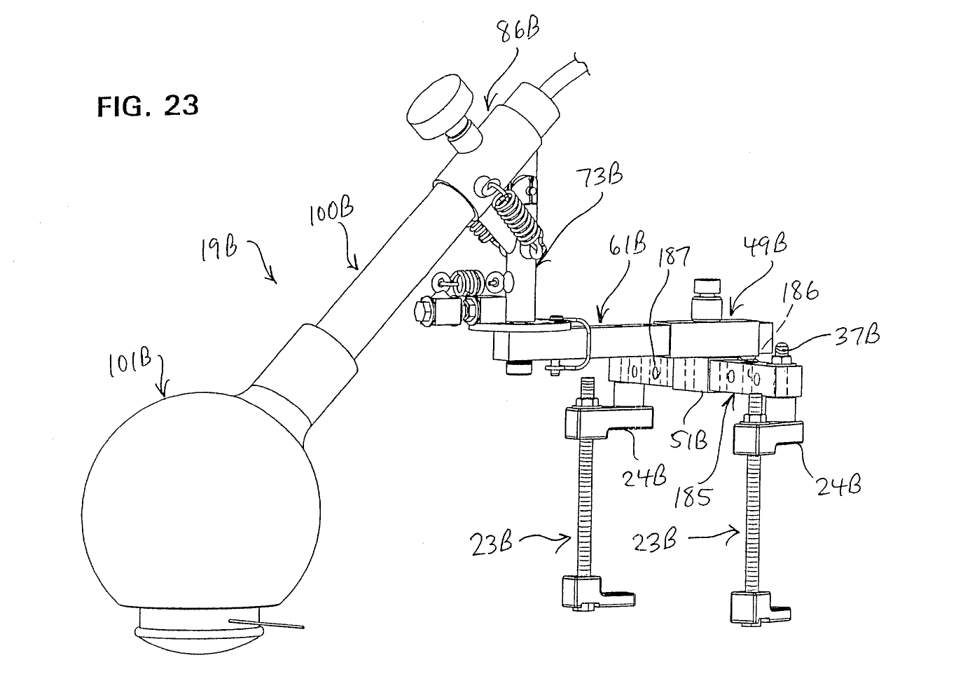

A further embodiment of the trimmer assembly is shown in FIG. 23. Trimmer assembly 19B is similar to trimmer assembly 19, and thus the same reference numbers plus a “B” will be utilized for components which are similar to or identical to components of trimmer assembly 19. In trimmer assembly 19B, the upper and lower mounting bars 32 and 40 are replaced with a single mounting bar 185 which defines therein a plurality of laterally-spaced bores 186 which extend between upper and lower surfaces thereof, and a plurality of side bores 187 which extend in a perpendicular manner relative to bores 186 between opposite upright side surfaces of bar 185. Each side bore 187 is disposed between an adjacent pair of bores 186.

Mounting bar 185 is inserted into lower sleeve 51B of sleeve assembly 49B, and the plunger of lower plunger is engaged within the selected side bore 187 of mounting bar 185 to secure bar 185 to slider arm 61B. Upper clamp members 24B are fastened to mounting bar 85 via threaded bolts 37B in a similar manner as clamp members 24 are attached to lower mounting bar 32 with respect to the first embodiment.

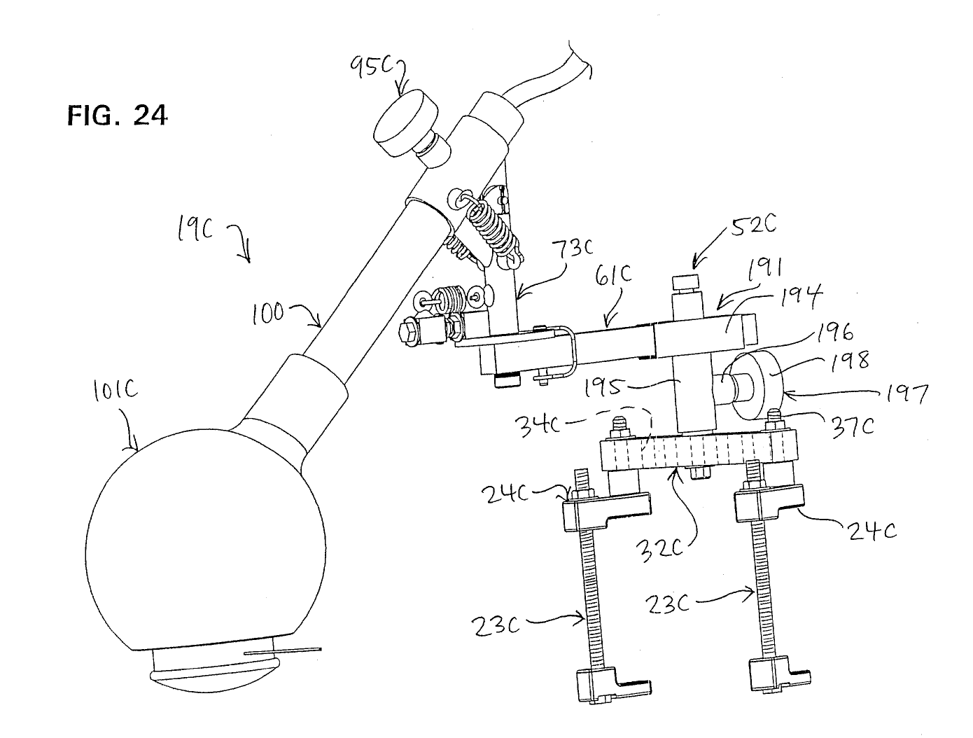

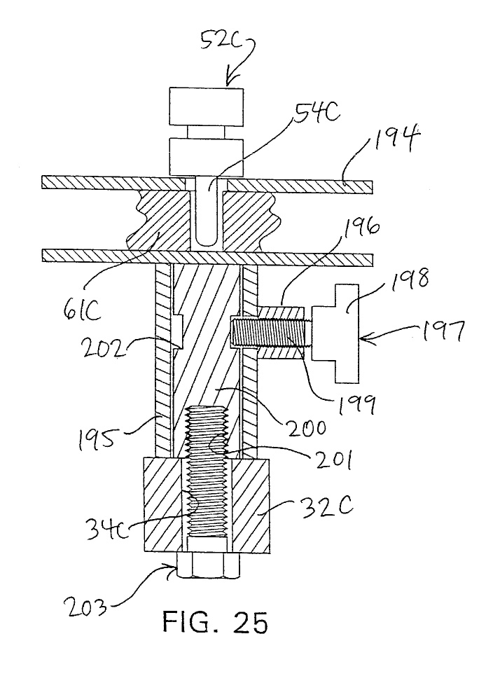

A further embodiment of the trimmer assembly 19 is depicted in FIGS. 24 and 25. The trimmer assembly 19C is similar to the trimmer assembly 19, and the same reference numbers plus a “C” are utilized with identical or similar components. In trimmer assembly 19C, upper mounting bar 40 is eliminated, and only lower mounting bar 32C is provided, along with a modified sleeve assembly 191. Upper clamp members 24C are secured to the mounting bar 32C via threaded bolts 37C in a similar manner as clamp members 24 are attached to lower mounting bar 32 with respect to the first embodiment.

The sleeve assembly 191 includes an upper sleeve 194 having a generally rectangular cross-section and mounting thereon a spring-loaded plunger 52C. A lower generally vertically oriented hollow cylinder 195 is fixed to a central area of the lower wall of sleeve 194 and is cantilevered downwardly therefrom. A tubular and internally threaded neck 196 is fixed to a side portion of cylinder 195 and projects sidewardly therefrom. A screw clamp 197 including a knob 198 and a screw 199 is threadingly engaged within neck 196. With reference to FIG. 25, an elongate rod or post 200 is disposed within cylinder 195. Rod 200 defines a downwardly opening threaded bore 201 therein, and additionally defines a sidewardly opening and continuous annular groove 202 spaced upwardly from bore 201 and at a height so as to be vertically aligned with neck 196. Rod 200 is fixed to an upper side of mounting bar 32C by a threaded bolt 203 which extends upwardly through a selected bore 34C of bar 32C and threadingly engages within bore 201. Cylinder 195 of sleeve assembly 191 is then fitted over rod 200, and the inner end of slider arm 61C is inserted into the upper sleeve 194 and plunger 52C is utilized to secure slider arm 61C to sleeve assembly 191 at the selected location.

The embodiment of FIGS. 24 and 25 allows rotational adjustment of the slider arm 61C relative to mounting bar 32C. More specifically, the rotational position of slider arm 61C is adjusted by loosening the screw clamp 197 by manually manipulating the knob 198 so that the screw 199 retracts away from the groove 202, rotating arm 61C and sleeve assembly 191 relative to mounting bar 32C about rod 200 to the selected location, and then tightening screw clamp 197 to bring the free end of screw 199 into engagement within groove 202 and against rod 200. It will be appreciated that this embodiment permits greater variation in the location of the trimmer head 101C than that provided by the rotating arm 73 and disc 65 of the first embodiment.

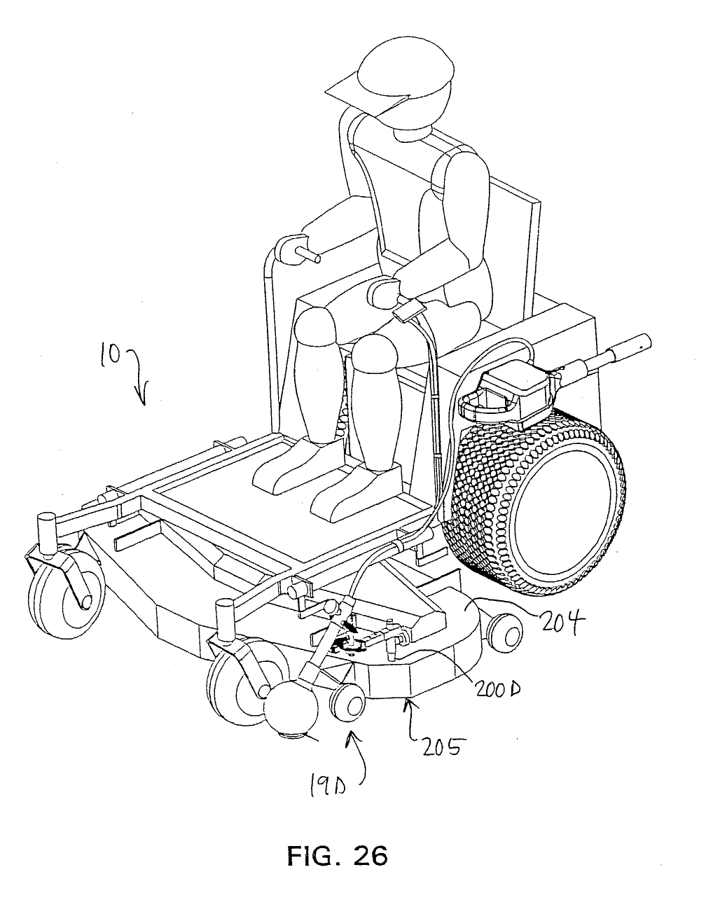

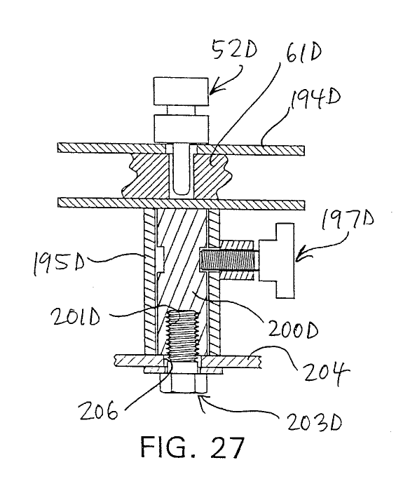

FIGS. 26-28 illustrate a further embodiment of the trimmer assembly which is intended for a more permanent mounting on a mower than the embodiments discussed above. The trimmer assembly 19D of this embodiment is similar to trimmer assembly 19C and utilizes the same components, except that the lower end of rod 200D is fixed to an upper wall 204 of a mower deck 205. More specifically, threaded bolt 203D is inserted upwardly through an opening 206 defined in upper wall 204 and threadingly engages within bore 201D of rod 200D.

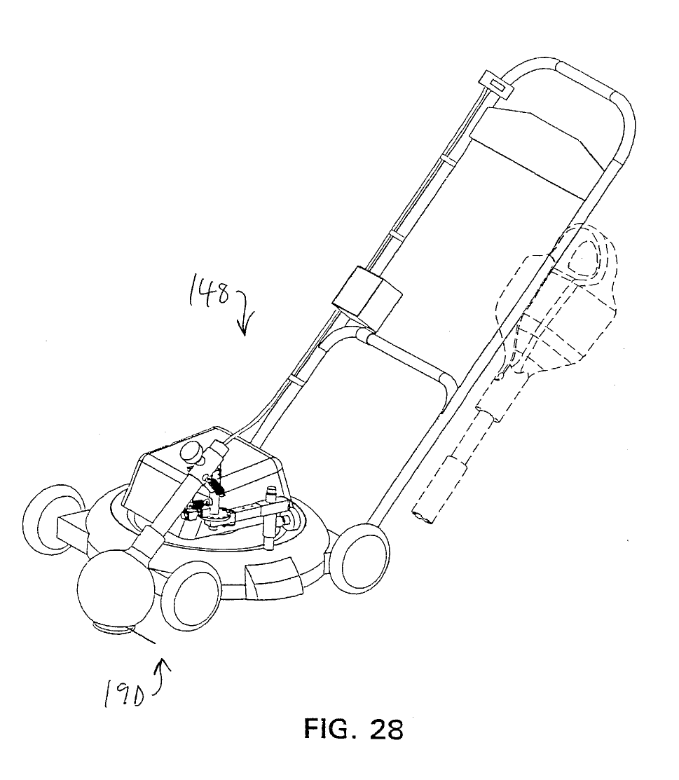

FIG. 26 shows the trimmer assembly 19D mounted on the commercial zero-turning radius mower 10 discussed above, and FIG. 28 shows the trimmer assembly mounted on the push-type mower 148.

The mounting bars, and slider arm may be constructed of steel, or other suitable rigid materials.

It will be appreciated that the trimmer assembly disclosed herein may incorporate a gasoline powered engine, meaning that the battery pack and power cord can be eliminated.

It will be appreciated that the trimmer head can be mounted so that the cutting swath thereof partially overlaps the cutting swath of the mower blade, or so that the cutting swath is spaced from the cutting swath of the mower. Further, it may be desirable to provide the trimmer assembly with a guard or shield which is positioned between the trimmer assembly and the operator so as to prevent injury from flying debris. It may also be desirable or necessary to mount the trimmer assembly to the mower frame instead of the mower deck or shroud, particularly with a commercial mower.

Although particular preferred embodiments of the invention have been disclosed in detail for illustrative purposes, it will be recognized that variations or modifications of the disclosed apparatus, including the rearrangement of parts, lie within the scope of the present invention.

1-2. (Cancelled).

3. A vegetation trimmer for attachment to a lawn mower having a mower deck which houses a vegetation cutting blade, said trimmer comprising a mounting arrangement adapted for coupling with the mower deck, and an arm assembly adjustably mounted on said mounting arrangement for movement relative thereto, said arm assembly resiliently supporting a powered trimmer head adjacent the mower deck for floating movement in both horizontal and vertical directions, said arm assembly including a first arm which mounts said trimmer head thereon in a vertically adjustable manner relative to the ground surface being trimmed, and a second arm which interconnects said first arm to said mounting arrangement, said first arm being resiliently connected to said second arm by a biasing arrangement to permit deflecting horizontal and floating movement of said trimmer head from an initial cutting position when said trimmer head encounters an obstacle and to return said trimmer head to said initial cutting position once said trimmer head is moved past the obstacle.

4. The trimmer of claim 3 wherein said biasing arrangement is a first biasing arrangement, said first arm has a lower end which is resiliently connected to one end of said second arm through said first biasing arrangement, and said first arm mounts thereon a trimmer head mounting bracket which is resiliently connected to said first arm by a second biasing arrangement which permits vertical floating movement of said trimmer head relative to said first arm.

5. The trimmer of claim 4 wherein said first arm is oriented in a generally vertical manner and defines a generally vertically oriented axis, said lower end of said first arm being rotatably movably disposed in an opening defined in said one end of said second arm, said one end of said second arm supports thereon a disc-like member which is rotatably adjustable relative to said one end into a plurality of predefined cutting positions to allow rotational adjustment of said trimmer head relative to the mower deck into a plurality of predefined positions, said disc-like member being connected to a lower end of said first arm by said first biasing arrangement to permit horizontal pivoting movement of said trimmer head and said first arm about the vertical axis and relative to said disc-like member and said second arm when an obstacle is encountered by said trimmer head.

6. The trimmer of claim 4 further including an elongate post having a lower end mounting said trimmer head thereon, said trimmer head mounting bracket comprising a sleeve in which an upper end of said post is disposed, said sleeve mounting thereon a downwardly depending stop element which abuts said first arm so as to define an initial vertical cutting position of said trimmer head, and said trimmer head is movable upwardly against the biasing force of said second biasing arrangement to allow said trimmer head to track the contour of the ground and to deflect upwardly when an obstacle on the ground is encountered by said trimmer head.

7. The trimmer of claim 6 wherein said post and said trimmer head mounted thereon are detachable from said trimmer head mounting bracket, said post being configured for electrical connection to a portable power pack such that said trimmer head is usable separately from the mower.

8. The trimmer of claim 3 wherein said mounting arrangement includes a pair of laterally spaced clamps which clampingly engage upper and lower edges of the mower deck.

9. The trimmer of claim 3 wherein said mounting arrangement includes an elongate and generally vertically oriented post having a lower end fixed to a generally horizontally oriented wall of the mower deck, and an upper end adjustably connected to said second arm.

10. A vegetation trimmer for attachment to a lawn mower having a mower deck which houses a vegetation cutting blade, said trimmer comprising a mounting arrangement adapted for coupling with the mower deck, and an arm assembly adjustably mounted on said mounting arrangement for movement relative thereto, said arm assembly resiliently supporting a powered trimmer head adjacent the mower deck for floating movement in both horizontal and vertical directions, said mounting arrangement including an elongate and generally vertically oriented post having a lower end fixed to a generally horizontally oriented wall of the mower deck, and an upper end adjustably connected to said arm assembly, said mounting arrangement further including a sleeve assembly having a first sleeve which engages over said post and a second sleeve which engages over a portion of said arm assembly, said sleeve assembly being rotatable relative to said post into a plurality of positions to permit positioning of said trimmer head in a plurality of cutting positions relative to the mower deck.

11. (Cancelled)

12. The trimmer assembly of claim 14 further including a mounting arrangement adjustably connected to said first arm, said mounting arrangement including a clamp which engages upper and lower portions of the mower deck.

13. The trimmer assembly of claim 12 wherein said first arm is slidingly adjustably connected to said mounting arrangement to permit positional adjustment of said trimmer along the mower deck and in directions toward and away from the mower deck.

14. A trimmer assembly for mounting on a lawn mower having a mower deck which houses a cutting blade, said trimmer assembly comprising:
a first arm positionably adjustably mounted to the mower deck;
a second arm mounting a powered trimmer thereon for cutting vegetation located generally adjacent the mower blade, said second arm being rotatably connected to said first arm to permit positioning of said trimmer in a plurality of cutting positions relative to the mower deck, said second arm including a first arm portion having a lower end rotatably connected to one end of said first arm and a second arm portion supporting said trimmer thereon, said first arm portion having an upper end pivotably and resiliently connected to said second arm portion to allow vertical floating and swinging movement of said trimmer relative to said first arm portion and said first arm when obstacles are encountered.

15. The trimmer assembly of claim 14 wherein said first and second arm portions are connected to one another by a biasing member which maintains said trimmer in a predetermined initial cutting position, said trimmer and said second arm portion being movable upwardly in opposition to the biasing force of said biasing member when an obstacle is encountered which exerts a generally upwardly directed force on said trimmer.

16. The trimmer assembly of claim 15 wherein said biasing member is a first biasing member, and said lower end of said first arm portion is connected to said one end of said first arm by a second biasing member which maintains said first and second arm portions and said trimmer in a predetermined rotational position relative to said first arm, said first and second arm portions and said trimmer being horizontally rotatably movable relative to said first arm in opposition to the biasing force of said second biasing member when an obstacle is encountered which exerts a generally sidewardly directed force on said trimmer.

17. (Cancelled)

18. The trimmer of claim 3 wherein said mounting arrangement is configured to permit mounting of said trimmer entirely within a footprint defined by the mower.

19. The trimmer of claim 3 wherein said trimmer further includes a power source which is configured for mounting on the mower, said power source being independent from a power source associated with driving said the mower.

20. (Cancelled)

21. The trimmer of claim 10 further including an elongate trimmer post having a lower end mounting said trimmer head thereon, said trimmer post and said trimmer head being detachable from said arm assembly, and said trimmer post being configured for electrical connection to a portable power pack such that said trimmer head is usable separately from the mower.

22. The trimmer assembly of claim 14 further including a mounting arrangement for coupling with the mower deck, and said mounting arrangement including a generally vertically oriented post having a lower end fixed to a generally horizontally oriented wall of the mower deck, and an upper end adjustably connected to said first arm.
